(19) United States
(12) Patent Application Publication
(10) Pub. No.: US 2026/0354397 A1
(43) Pub. Date: Nov. 12, 2026

(54) LIQUID COMPOSITION OF COMPLEX RARE SACCHARIDE HAVING SIGNIFICANTLY IMPROVED CHARACTERISTICS WITH RESPECT TO BROWNING AND SHELF LIFE

(71) Applicant: UIF (UNIVERSITY INDUSTRY FOUNDATION), YONSEI UNIVERSITY, Seoul (KR)

(72) Inventor: Seong-Bo KIM, Seongnam-si Gyeonggi-do (KR)

(21) Appl. No.: 19/475,379

(22) PCT Filed: Apr. 12, 2024
(86) PCT No.: PCT/KR2024/004947

§ 371 Date: Oct. 14, 2025

(30) Foreign Application Priority Data
Apr. 14, 2023 (KR) 10-2023-0049312

(51) Int. Cl. A23B 2/779; A23L 27/30

(52) U.S. Cl. CPC A23B 2/779; A23L 27/33

(57) ABSTRACT

An embodiment relates to a complex rare sugar liquid composition with significantly improved browning and shelf-life characteristics. Specifically, in order to solve the problems of short shelf-life and browning of D-allulose, which is the only natural sugar capable of serving as a substitute for sucrose, the embodiment implements a complex sugar composed of non-metabolizable rare sugars including D-allulose. Through such implementation, the embodiment resolves the issues of browning and shelf-life, and provides an effective substitute for conventional sucrose and high-fructose sugars without raising blood glucose levels.

### TECHNICAL FIELD

The present invention relates to a complex rare sugar liquid composition with significantly improved browning and shelf-life characteristics. Although D-allulose, the only natural zero-calorie sugar material, can be manufactured into high-purity liquid or crystalline products, D-allulose has inherent limitations in versatility for food processing due to its short shelf-life and rapid browning characteristics. The present invention is directed to providing a rare sugar liquid composition that exhibits browning inhibition and crystallization suppression effects.

### BACKGROUND ART

With the growing global awareness of sugar reduction, the most important functional appeal points of alternative sweetener materials are concentrated on “natural” and “calorie.” To date, the only industrialized examples of sugar-reducing sweeteners (low- or non-calorie sweeteners) that can be marketed as zero-calorie are erythritol and D-allulose. While erythritol belongs to the sugar alcohols, D-allulose belongs to sugars; thus, D-allulose is the only sugar that can be positioned as a zero-calorie sweetener. In particular, D-allulose provides a significant advantage of relatively superior flavor quality due to the Maillard reaction.

D-allulose has high solubility in aqueous solution, similar to fructose. Due to this inherent property, the theoretical maximum yield of crystalline products is low, at a level of about 20-25%, which results in a very high cost for crystalline products. Because of such structural cost limitations, the current D-allulose market is concentrated on high-purity liquid products (purity of 95% or more based on solids). Meanwhile, in order to qualify for zero-calorie labeling, liquid D-allulose must be of high purity (95% or more solids content), and in order to ensure food safety during storage, it must be manufactured with at least 70% solids content to achieve appropriate water activity.

To maintain the zero-calorie appeal, liquid products must be maintained as single-component solutions of D-allulose. However, such high-concentration single-component solutions are accompanied by quality issues due to crystallization and precipitation at low temperatures, which requires that room temperature conditions be continuously maintained during distribution and storage. In addition, since D-allulose is a keto-hexose possessing rapid browning characteristics, prolonged exposure at room temperature causes rapid deterioration of the product (in terms of color and purity). In fact, liquid D-allulose products, at 75 Brix, are limited to a shelf-life of 6 months or less. Currently, D-allulose, as the only natural zero-calorie sugar, can be manufactured into high-purity liquid or crystalline products, but because of its inherently short shelf-life (liquid) and rapid browning characteristics (liquid, crystalline), its applications are inevitably restricted to domestic distribution and beverage-centered use. Accordingly, there is a need for improvement research to overcome these limitations.

Against this background, the inventors of the present invention assessed the possibility of complex sugars composed of non-metabolizable rare sugars that qualify for zero-calorie labeling, and, as a result of extensive effort to solve the above problems, completed the present invention by identifying a rare sugar liquid composition that suppresses browning and crystallization of D-allulose through simple enzymatic reactions rather than by complex chemical synthesis methods for artificial sweeteners.

### DETAILED DESCRIPTION OF THE INVENTION

### Technical Problem

One object of the present invention is to provide a rare sugar liquid composition comprising D-allulose and D-allose.

Another object of the present invention is to provide a composition for preventing browning of D-allulose, comprising D-allose.

Still another object of the present invention is to provide a composition for preventing crystallization of D-allulose, comprising D-allose.

Still another object of the present invention is to provide a method for inhibiting or preventing browning of a liquid product containing D-allulose, comprising adding D-allose or a composition comprising the same.

Still another object of the present invention is to provide a method for inhibiting or preventing crystallization of a liquid product containing D-allulose, comprising adding D-allose or a composition comprising the same.

Still another object of the present invention is to provide a method for producing a rare sugar liquid composition, comprising: enzymatically reacting D-allulose as a substrate to convert D-allulose into D-allose; and separating and purifying unconverted D-allulose and D-allose.

Still another object of the present invention is to provide a rare sugar liquid composition produced by the method for producing a rare sugar liquid composition.

### Technical Solution

The present invention is described more specifically as follows. Meanwhile, each description and embodiment disclosed in the present invention can be applied to other descriptions and embodiments. That is, all combinations of the various elements disclosed in the present invention fall within the scope of the invention. Furthermore, the scope of the present invention is not considered to be limited by the specific descriptions provided below.

The term “monosaccharide” as used in the present invention means the most basic unit of carbohydrate that cannot be hydrolyzed into simpler compounds, does not undergo hydrolysis under normal conditions, exhibits sweetness, and is a colorless crystal that is readily soluble in water. The elemental composition is represented by (CH₂O)ₙ, indicating that one carbon atom is hydrated with one molecule of water.

Specifically, monosaccharides are broadly classified according to the state of the reducing group (carbonyl group) into aldoses (sugars having an aldehyde group as the carbonyl group), ketoses (sugars having a ketone group as the carbonyl group), and sugar alcohols (also called polyols, sugars not having a carbonyl group). Among them, rare sugars are also included within monosaccharides.

The term “rare sugar” as used in the present invention means a monosaccharide that exists only in trace amounts in nature. According to the definition by the International Society of Rare Sugars, rare sugars are defined as sugars that are rarely present in the natural world.

Specifically, they can be mass-produced by using general monosaccharides such as glucose or fructose as raw materials and applying chemical methods or microbial enzyme conversion methods.

More than 50 types of rare sugars have been reported, and both D-allulose and D-allose of the present invention may be rare sugars.

The rare sugars are non-metabolizable monosaccharides that are hardly converted into calories in the body, and thus can be used as zero-calorie sweeteners.

The terms “zero-calorie” and “low-calorie” as used in the present invention mean having no or extremely few calories by using sugars that are not metabolized in the human body, instead of caloric sweeteners such as sucrose.

Specifically, sugars not metabolized in the human body may mean those having 0.4 kcal/g or less, and they possess health functionalities such as aiding in obesity and diabetes management.

The term “D-allulose” as used in the present invention refers to a rare sugar contained in small amounts only in natural plants such as grapes or figs, which has drawn attention as an alternative sweetener because it provides sweetness very similar to sucrose while having low calories.

Specifically, D-allulose is a monosaccharide containing six carbon atoms, is a ketose having a ketone group, has the chemical formula C6H12O6, and is also called psicose.

More specifically, D-allulose has a very low actual caloric value of 0.2 to 0.4 kcal per gram, and has effects such as improving insulin sensitivity, antioxidant activity, and blood glucose regulation. Accordingly, it is attracting attention as a sweetener with near-zero calories while providing sweetness. However, since D-allulose possesses rapid browning characteristics, prolonged exposure under room temperature conditions causes rapid deterioration of the product, and liquid D-allulose samples at 75 Brix are limited to a shelf-life of 6 months or less, which restricts versatility in food processing.

The present invention aims to improve the problems of short shelf-life caused by browning and crystallization of D-allulose. Specifically, the present invention provides a complex sugar including D-allose, without complicated chemical synthesis, so that the problems of browning and crystallization of D-allulose can be improved without reducing the sucrose-like sweetness of a natural zero-calorie sweetener.

Accordingly, the present invention provides a rare sugar liquid composition comprising D-allulose and D-allose.

In order to achieve the above-mentioned objects, a first aspect of the present invention provides a rare sugar liquid composition comprising D-allulose and D-allose.

In addition, a second aspect of the present invention provides a composition for preventing browning of D-allulose, comprising D-allose.

In addition, a third aspect of the present invention provides a composition for preventing crystallization of D-allulose, comprising D-allose.

Hereinafter, the present invention will be described in more detail.

The term “D-allose” as used in the present invention is a monosaccharide containing six carbon atoms, which is an aldose having an aldehyde group, and has the chemical formula C₆H₁₂O₆. D-allose is a rare monosaccharide generated as 6-O-cinnamyl glycoside in the leaves of an African shrub, Protea rubropilosa.

The D-allose may be produced through enzymatic conversion from D-allulose.

Specifically, D-allose can be generated at minimal cost by inducing structural variation within the same molecular weight through enzymatic conversion (a single reaction) from D-allulose.

The term “enzyme” as used in the present invention refers to a protein catalyst that binds to a specific reactant and lowers the activation energy to accelerate the reaction.

Specifically, the “enzyme” is an aldose-ketose isomerase that converts ketose sugar-based rare sugar D-allulose into aldose sugar-based rare sugar D-allose.

The aldose-ketose isomerase used in the present invention belongs to EC 5.3.1 and includes triosephosphate isomerase, ribose-5-phosphate isomerase, mannose phosphate isomerase, glucose isomerase, and L-rhamnose isomerase.

In the embodiments of the present invention, L-rhamnose isomerase was used as the aldose-ketose isomerase; however, the invention is not limited thereto.

The content of D-allose in the composition may be 5-50% (W/W).

If the content of D-allose is less than 5% (W/W), the effect of inhibiting browning and crystallization of D-allulose may be insignificant. To enhance the inhibitory effect on browning and crystallization of D-allulose, preferably, the content of D-allose in the composition may be 10% or more, for example, 20% (W/W) or more. Although the maximum content of D-allose in the composition is not particularly limited, it is technically difficult to increase the content of D-allose to more than 50% through a single enzymatic conversion reaction without separate purification.

Accordingly, preferably, the content of D-allose in the composition is 20-40% (W/W), for example, 20-33% (W/W), but the invention is not limited thereto.

The sugar concentration of the rare sugar liquid composition may be 60-90 Brix.

Preferably, the sugar concentration of the rare sugar liquid composition may be 70-80 Brix. Specifically, when the sugar concentration is less than 60 Brix, quality deterioration may occur due to microbial reactions, and when it exceeds 90 Brix, supersaturation may cause crystallization and precipitation problems.

The rare sugar liquid composition according to the present invention may, although not intentionally, further comprise other sugars in addition to D-allulose and D-allose in the enzymatic conversion reaction converting D-allulose into D-allose.

The other sugar may be, for example, a monosaccharide. The monosaccharide may include aldotrioses (glyceraldehyde), ketotrioses (dihydroxyacetone), aldotetroses (erythrose, threose), ketotetroses (erythrulose), aldopentoses (arabinose, lyxose, ribose, xylose), ketopentoses (ribulose, xylulose), deoxysugars (deoxyribose), aldohexoses (allose, altrose, galactose, glucose, gulose, idose, mannose, talose), ketohexoses (fructose, allulose, sorbose, tagatose), deoxysugars (fucose, fuculose, rhamnose), and ketoheptoses (mannoheptulose, sedoheptulose), which may generate HMF, without limitation.

Specifically, it may be a hexose, more specifically, fructose, but is not limited thereto.

The rare sugar liquid composition according to the present invention may, although not intentionally, further comprise fructose as another sugar in addition to D-allulose and D-allose in the enzymatic conversion reaction converting D-allulose into D-allose.

The weight ratio of the rare sugar liquid composition may satisfy the purpose of providing a zero-calorie sweetener substituting sucrose at minimal cost.

Another aspect of the present invention for achieving the above object is to provide a composition for preventing browning of D-allulose, comprising D-allose.

The D-allose may be produced through enzymatic conversion from D-allulose.

The term “preventing browning” as used in the present invention may be used to mean preventing, delaying, or inhibiting browning during cooking, processing, or storage of a food or a composition containing sugar (D-allulose), and may be used interchangeably in the present invention. For example, browning reactions in foods such as cereals and cereal bars, potato chips, bakery products, carbonated beverages, fruit and vegetable juices, fruit drinks, fruit wines, sauces, candies, jellies, jams, ice cream, and beer cause deterioration of quality, including loss of aroma, flavor, and nutritional value.

Materials containing sugar (D-allulose) may undergo browning through the Maillard reaction.

The term “Maillard reaction” as used in the present invention is also called caramelization reaction, and refers to a browning reaction in which the carbonyl group of a sugar and the amino group of a protein react upon heating to generate brown substances (melanoidins). Specifically, this reaction is also referred to as the melanoidin reaction, named after the reaction products, or as the amino-carbonyl reaction arising from the reactants.

More specifically, the Maillard reaction proceeds rapidly at high temperatures to cause browning, but can also be observed during storage at room temperature. In the present invention, D-allose is used to suppress the Maillard reaction of D-allulose to prevent browning and thereby extend the shelf-life beyond the conventional 6-month limit.

Another aspect of the present invention for achieving the above object is to provide a composition for preventing crystallization of D-allulose, comprising D-allose.

The D-allose may be produced through enzymatic conversion from D-allulose.

The term “preventing crystallization” as used in the present invention may be used to mean preventing, delaying, or inhibiting the precipitation of crystals from a liquid phase, and may be used interchangeably in the present invention.

Specifically, D-allulose of the present invention may undergo crystal precipitation at low temperatures (1 °C to 20 °C), and such crystal precipitation may be inhibited by adding D-allose.

Another aspect of the present invention for achieving the above object is to provide a method for inhibiting or preventing browning of a liquid product containing D-allulose, comprising adding D-allose or a composition comprising the same.

Another aspect of the present invention for achieving the above object is to provide a method for inhibiting or preventing crystallization of a liquid product containing D-allulose, comprising adding D-allose or a composition comprising the same.

The D-allose may be included in the liquid product containing D-allulose to suppress the problems of browning and crystallization of D-allulose.

Another aspect of the present invention for achieving the above object is to provide a method for producing a rare sugar liquid composition, comprising: enzymatically reacting D-allulose as a substrate to convert D-allulose into D-allose; and separating and purifying unconverted D-allulose and D-allose.

The enzyme for converting D-allulose into D-allose may be an aldose-ketose isomerase as described above, and specifically, the enzyme may be triosephosphate isomerase, ribose-5-phosphate isomerase, mannose phosphate isomerase, glucose isomerase, or L-rhamnose isomerase, but is not limited thereto.

The converting may be performed so that the content of D-allose in the produced composition is 20-33% (W/W) relative to the total weight.

The converting may be a biological enzymatic conversion method, not a complex chemical synthesis method, and may be a simple method applicable in a single process.

In addition, to solve the problems of browning and crystallization of D-allulose, the invention may provide a complex sugar by converting D-allulose into D-allose at 20-33%.

The method may further comprise adding D-allose so that the content of D-allose in the produced composition is 5-50% (W/W) relative to the total weight.

The composition may additionally comprise D-allose in addition to the D-allose converted through the enzymatic conversion method.

Another aspect of the present invention for achieving the above object is to provide a rare sugar liquid composition produced by the method for producing a rare sugar liquid composition according to the above-described biological process.

The rare sugar liquid composition, the composition for preventing browning of D-allulose, and the composition for preventing crystallization of D-allulose may be included in a food composition.

In addition, the food composition may include the rare sugar liquid composition.

When browning occurs due to inclusion of D-allulose in a food composition, the browning and crystallization of the food composition can be prevented by preparing and including the rare sugar liquid composition of the present invention instead of D-allulose.

The term “prepare” as used in the present invention is intended to encompass without limitation any method of providing a composition comprising D-allulose and D-allose. That is, any method of ensuring that a composition includes D-allulose and D-allose is encompassed. For example, preparing a composition comprising D-allulose and D-allose may include adding D-allose to a composition comprising D-allulose, adding D-allulose to a composition comprising D-allose, or generating D-allose during production of a D-allulose composition.

The composition need only comprise D-allulose and D-allose, and other components may be included without limitation.

Meanwhile, a composition comprising D-allulose and D-allose may also be referred to as a “mixture composition.” The mixture composition may further include other sugars, for example, fructose, but is not limited thereto.

The food composition may include general foods, health foods, and medical (or patient) foods, but is not limited thereto. Specifically, the food composition of the present application may be beverages (e.g., carbonated beverages, fruit juice beverages, fruit and vegetable beverages, dietary fiber beverages, sparkling water, grain powder drinks, tea, coffee, etc.), alcoholic beverages, bakery products, sauces (e.g., ketchup, pork cutlet sauce, etc.), dairy products (e.g., fermented milk, processed milk, etc.), processed meat products (e.g., ham, sausage, jerky, etc.), processed chocolate products, chewing gum, candies, jellies, ice cream, syrups, dressings, snacks (e.g., cookies, crackers, biscuits, etc.), pickled fruit and vegetables (e.g., fruit preserves, sugar-infused fruit, red ginseng extract or red ginseng slices, etc.), meal replacement foods (e.g., frozen foods, retort foods, and HMR (home meal replacement) products), or processed foods. However, these are merely examples and not limiting.

The food composition of the present invention may further contain various flavoring agents or natural carbohydrates as additional ingredients. The above-mentioned natural carbohydrates include monosaccharides such as glucose and fructose, disaccharides such as maltose and sucrose, polysaccharides such as dextrin and cyclodextrin, and sugar alcohols such as xylitol, sorbitol, and erythritol. As sweeteners, natural sweeteners such as thaumatin and stevia extract, or synthetic sweeteners such as sucralose, saccharin, and aspartame may be used.

The food composition may contain various nutrients, vitamins, electrolytes, flavoring agents, coloring agents, pectin and its salts, alginic acid and its salts, organic acids, protective colloid thickeners, pH regulators, stabilizers, preservatives, glycerin, alcohol, acidulants and salting agents used in carbonated beverages, etc. In addition, the food composition of the present application may contain fruit pulp for producing natural fruit juice, fruit juice beverages, and vegetable beverages. These ingredients may be used independently or in combination. Moreover, substances that can ordinarily be included in food compositions may be appropriately selected and added by a person skilled in the art, and the ratio of such additives may be selected within the range of 0.001-1 part by weight, or 0.01-0.20 part by weight, per 100 parts by weight of the food composition of the present application, but is not limited thereto.

In a specific embodiment, it was confirmed that the rare sugar liquid composition of the present invention inhibited browning and crystallization of D-allulose.

Therefore, through the specific embodiment, it is suggested that the rare sugar liquid composition of the present invention can further be used as a core technology for natural zero-calorie foods.

### Advantageous Effects

The rare sugar liquid composition of the present invention, as a natural zero-calorie sweetener, solves the conventional problems of D-allulose, namely short shelf-life, browning, and crystallization.

### DESCRIPTION OF THE DRAWINGS

FIG. 1 is a schematic diagram showing a bioreactor for producing D-allose according to the present invention.

FIG. 2 is a schematic diagram showing ion-exchange chromatography for high-purity purification of D-allose according to the present invention.

FIG. 3 is a graph showing the browning reaction of D-allulose depending on the content of D-allose according to the present invention.

FIG. 4 is a photograph showing comparative results of a crystallization acceleration test depending on temperature for the rare sugar liquid composition of the present invention and D-allulose.

### BEST MODE

The present invention will be described in more detail below through Examples. These Examples are intended to describe the invention in greater detail, and are not to be construed as limiting the scope of the invention.

### Preparative Example 1: Production of E. coli BL21 (DE3)/GSLRI Having D-Allose Converting Enzyme

In order to obtain a D-allose converting enzyme that converts D-allulose as a substrate into D-allose, gene synthesis of Geobacillus sp. BMUD-derived L-rhamnose isomerase (hereinafter, GSLRI) was commissioned based on E. coli. A pBT-C-His-GSLRI vector was obtained. Through heat-shock transformation, E. coli BL21 (DE3) was transformed with the recombinant vector to obtain E. coli BL21 (DE3)/GSLRI.

### Preparative Example 2: Enzyme Expression and Production of Immobilized Beads

To perform sugar conversion reaction from allulose to allose as a substrate, expression of the D-allose converting enzyme was induced from E. coli BL21 (DE3)/GSLRI obtained in Preparative Example 1.

Specifically, a single colony of E. coli BL21 (DE3)/GSLRI was inoculated into 10 mL of LB medium containing 50 μg/mL ampicillin and cultured overnight at 37 °C, 200 rpm. The culture broth was inoculated at 2% into 500 mL of LB medium containing 50 μg/mL ampicillin and 5 mM lactose, and cultured for 18 hours at 30 °C, 150 rpm. The culture was carried out in 8 flasks by the same method, and the completed culture broths were collected together and used for bead preparation.

To immobilize cells into beads, the culture broth was centrifuged at 4,000 rpm, 4 °C for 20 minutes, and 20% of the E. coli BL21 (DE3)/GSLRI cells were suspended in 0.85% NaCl, then mixed with 2% sodium alginate and 0.2% SiO₂. The mixture containing 20% cells was dropped into 0.1 M CaCl₂) solution using a syringe pump to produce immobilized beads. The beads produced were washed 2-3 times with 0.1 M CaCl₂) solution to increase hardness, and then placed in substrate solution for immobilized reaction and stored at 4 °C.

As a control, E. coli BL21 (DE3) not having a D-allose converting enzyme was cultured under the same conditions and immobilized beads were prepared by the same method, and used as a control group in the following Experimental Examples.

### Preparative Example 3: Production of D-Allulose and D-Allose Mixed Solution Through Immobilized Reaction

To select the optimal substrate concentration for the immobilized reaction, reaction condition experiments were conducted using beads prepared in Preparative Example 2.

The prepared beads were divided into microtubes in small amounts, and 20 mM Tris-HCl (pH 7.0) and 5 mM MnCl₂ were added, and then 0.1 M, 0.2 M, or 0.5 M of D-allulose was additionally added to each tube. The tubes were reacted at 60 °C for 1, 2, or 4 hours, and then the reaction was stopped at 4 °C. Thereafter, only the supernatant of the completed reaction tubes was collected, filtered through a 0.22 μm membrane filter, and analyzed by HPLC. The HPLC analysis confirmed that enzymatic conversion activity to D-allose was highest in immobilized beads reacted in 0.2 M D-allulose substrate buffer.

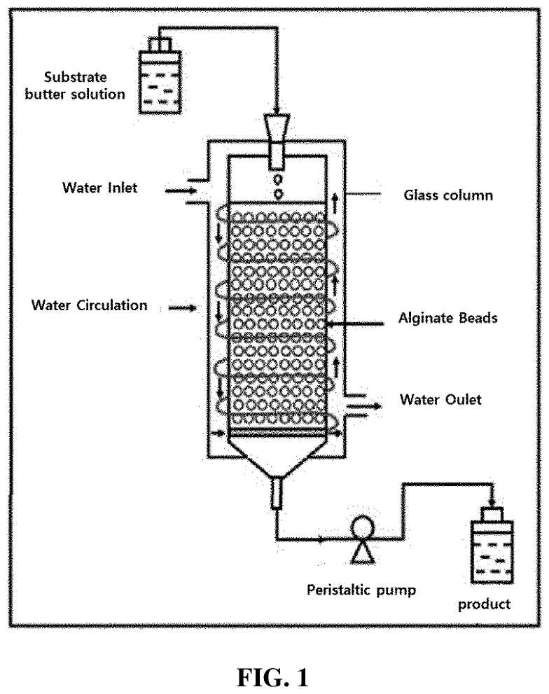

Using the optimized condition, 40 mL of immobilized beads was packed into a bioreactor, and an immobilized reaction was carried out using 20 mM Tris-HCl (pH 7.0) buffer containing 0.2 M D-allulose and 5 mM MnCl₂. A batch circulator was used to maintain the column temperature at 50 °C, and the immobilized reaction was carried out for 30 days. In the bioreactor, fluid was passed through a glass column (outer O/D 56 mm, inner O/D 30 mm, inner I/D 26 mm, height 150 mm) at a flow rate of 0.3 mL/min (see FIG. 1).

Specifically, as shown in FIG. 1, a packed-bed bioreactor was used, and 40 mL of immobilized beads containing E. coli BL21 (DE3)/GSLRI cells was fixed in alginate beads. A substrate buffer solution containing 0.2 M D-allulose and 5 mM MnCl₂ in 20 mM Tris-HCl (pH 7.0) was passed at a flow rate of 0.3 mL/min to perform enzymatic conversion and obtain D-allose as a product.

The immobilized reaction was carried out under the same conditions as described above in two groups: a control group (immobilized beads of E. coli BL21 (DE3)) and an experimental group (immobilized beads of E. coli BL21 (DE3)/GSLRI), using the same substrate buffer, flow rate, and bead preparation conditions.

Accordingly, a D-allulose solution was obtained in the control group, and a D-allulose+D-allose mixed solution was obtained in the experimental group.

A portion of the D-allulose+D-allose mixed solution obtained from the experimental group was filtered with a 0.22 μm membrane filter (Advantec, Toyo Roshi Kaisha, Ltd., Japan), and analyzed by HPLC (Agilent 1100 series, USA) to confirm the conversion rate and production amount of D-allose generated from D-allulose substrate. As a result, it was confirmed that the conversion rate was maintained at 20% or more for about 30 days.

To produce a high-purity sugar solution, the obtained D-allulose single solution and the D-allulose+D-allose mixed solution were subjected to desalination and decolorization processes by ion purification and activated carbon treatment.

### Preparative Example 4: Production and Purification of Sugar Solution

The reaction solution obtained from the immobilized system using the above bioreactor was collected and concentrated to 25 Brix using a vacuum evaporator (EYELA, CCA-1112A, China). The sugar concentration (Brix) was measured using a refractometer (ATAGO, 3810 PAL-1, Japan).

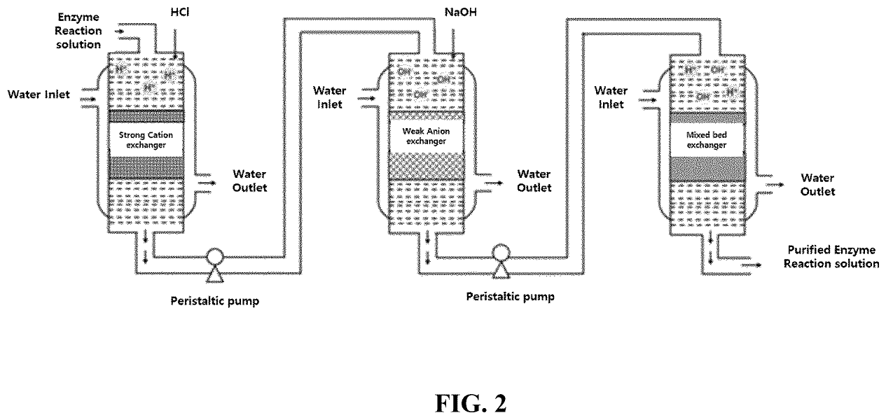

As shown in FIG. 2, in order to remove ionic substances in the concentrated reaction solution, ion exchange chromatography resin was used. Three columns (outer O/D 90 mm, inner O/D 65 mm, inner I/D 60 mm, height 250 mm) were each packed with 300 mL of strong cation exchange (SK), 500 mL of weak anion (WA), and 200 mL of mixed bed (MB) resin, respectively. The 25 Brix concentrated sugar solution was sequentially separated and purified through the columns at a flow rate of 20 mL/min, and the purified reaction solution was further concentrated to 30 Brix by the same method as the concentrate described above.

The obtained reaction solution was subjected to a treatment process using activated carbon to adsorb proteins, impurities, etc., in the solution, and for decolorization and deodorization. 50 g of activated carbon was washed several times with 500 mL of triple distilled water, and then all remaining moisture was removed using a vacuum pump. The wet weight of the activated carbon was then measured to prepare 0.5% activated carbon. The obtained concentrated 30 Brix solution was added to the washed activated carbon and filtered, and the process was repeated until the sample no longer exhibited color, thereby purifying the sample.

The repeatedly purified reaction solution, which appeared transparent, was concentrated to 30 Brix under the same conditions as the concentration method described above. The obtained concentrate was used for the experiments of browning and crystallization precipitation reaction of the sugar solution caused by the addition of allulose.

The analysis results for the components, concentrations, and contents of Sample 1 and

Sample 2 are shown in Table 1 below.

TABLE 1

| | | | Concentration | Content |
|---|---|---|---|---|
| Sample | | Component | (g/L) | (%) |
| Sample 1 | Control | Fructose | 14.0768 | 4.99 |
| | (allulose) | Allulose | 267.99594 | 95.01 |
| Sample 2 | Experimental, | Fructose | 12.1353 | 4.37 |
| | (allulose + allose) | Allulose | 207.54181 | 74.75 |
| | | Allose | 57.95437 | 20.87 |

### Experimental Example 1: Experiment on the Effect of Changes in D-Allose Content on the Browning Reaction of D-Allulose

The sugar solution was concentrated to 70 Brix using a vacuum evaporator in order to confirm the effect of changes in D-allose content on the browning reaction of D-allulose.

Sample sugar solutions A, B, C, D, and E were prepared by mixing and diluting Sample 2 and Sample 1 so that the final D-allose contents became 0, 5, 10, 15, and 20% (w/w), respectively. The prepared sample solutions were each mixed with 20% glycine aqueous solution at a ratio of 1:1 to prepare sugar-amino acid solutions for testing the Maillard reaction.

The prepared sugar-amino acid solutions were placed 200 mL each into safe-lock tubes, and without pH adjustment, heated in a heat block at 100 °C for 5, 10, or 15 minutes. The time when the temperature reached 100 °C was taken as the starting point, and after heating for 5, 10, and 15 minutes, the tubes were removed and cooled in running tap water. The absorbance of the Maillard browning reaction solution was measured at a wavelength of 420 nm using a UV-VIS spectrophotometer (Infinite M200 Pro, TECAN, Switzerland).

TABLE 2

| Sample sugar solution | A | B | C | D | E |
|---|---|---|---|---|---|
| (Allose content) | (0% w/w) | (5% w/w) | (10% w/w) | (15% w/w) | (20% w/w) |
| O.D value (420 nm)_5 | 0.6675 ± 0.02 | 0.6111 ± 0.02 | 0.5528 ± 0.01 | 0.4896 ± 0.02 | 0.4354 ± 0.01 |
| min | | | | | |
| O.D value (420 nm)_10 | 1.3790 ± 0.06 | 1.2939 ± 0.04 | 1.2076 ± 0.03 | 1.1127 ± 0.03 | 1.0159 ± 0.03 |
| min | | | | | |
| O.D value (420 nm)_15 | 2.1279 ± 0.01 | 2.0336 ± 0.03 | 1.9313 ± 0.03 | 1.8155 ± 0.02 | 1.7249 ± 0.01 |
| min | | | | | |

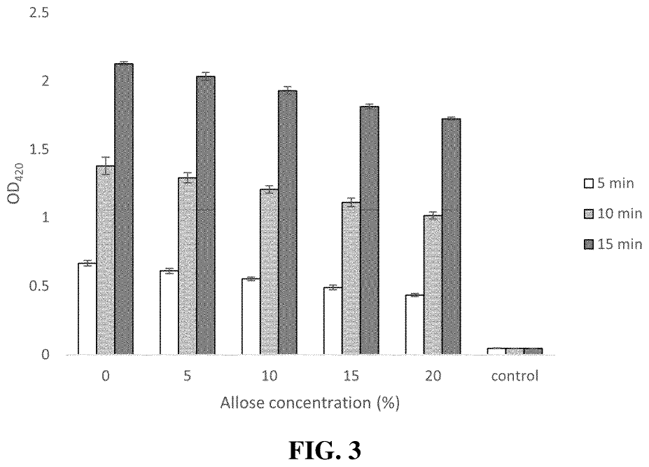

As shown in Table 2 and FIG. 3, when the content of D-allose was 0%, the absorbance value was the highest, 2.1279±0.01, based on the 15-minute browning reaction solution. As the content of D-allose increased, the absorbance value decreased to 1.7249±0.01, based on the 15-minute browning reaction solution. This confirmed that, compared to D-allulose alone, the higher the content of D-allose, the slower the browning rate under heating conditions.

### Experimental Example 2: Crystallization Acceleration Test

A crystallization acceleration test depending on temperature was performed for the D-allulose syrup composition. This was conducted to confirm whether crystallization of D-allulose occurs under refrigerated and room temperature conditions when D-allose is added, since crystallization readily occurs for D-allulose at low temperatures.

Syrup containing only D-allulose and syrup containing both D-allulose and D-allose at 70 Brix were each dispensed into vials at 1 mL and allowed to stand at 4 °C, 10 °C, and 30 °C for 24 hours. Then, 0.2% of D-allulose crystal seed was mixed into each vial and stored under the same temperature conditions for an additional 24 hours. The D-allulose crystal seed was prepared by finely grinding D-allulose.

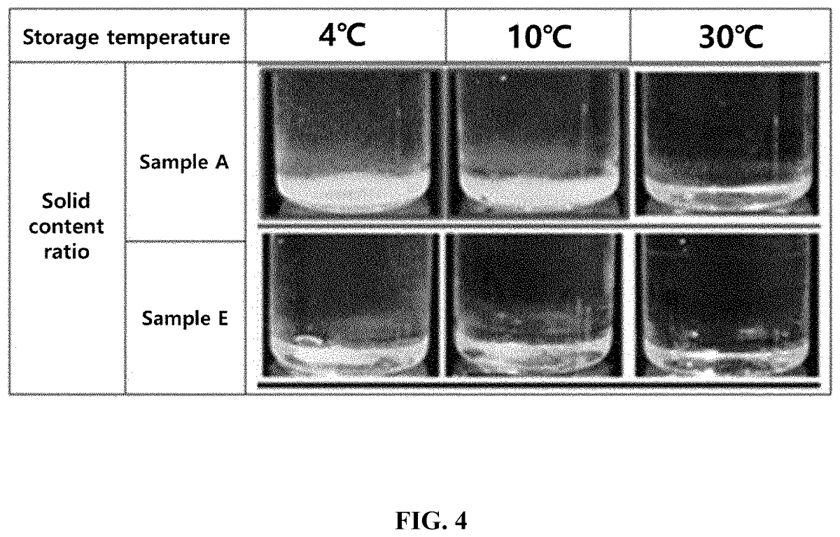

As shown in FIG. 4, the results of crystallization precipitation at different temperatures for Sample A and Sample E of Experimental Example 1 indicated that, in the case of the D-allulose single component (Sample A), turbidity occurred at low temperature, whereas in the case of the D-allulose syrup containing D-allose (Sample E), turbidity did not occur. This suggests that when using only D-allulose, storage and distribution must be maintained at room temperature (20-30 °C), whereas when D-allose is included, storage and distribution at low temperature conditions are also feasible.

Taken together, the results of the above experiments confirmed that the rare sugar liquid composition of the present invention, by including D-allose in the D-allulose composition, can retard the browning reaction and crystallization rate of D-allulose.

From the above description, those skilled in the art will understand that the present invention can be implemented in other specific forms without changing the technical spirit or essential characteristics thereof. In this regard, the embodiments described above are to be understood as illustrative in all respects and not restrictive. The scope of the invention should be interpreted as including all modifications or variations derived from the meaning and scope of the claims described below and their equivalents, rather than from the foregoing detailed description.

1-11. (canceled)

12. A method for inhibiting or preventing browning of a liquid product comprising D-allulose, comprising adding D-allose or a composition comprising the same.

13. The method for inhibiting or preventing the browning of the liquid product comprising the D-allulose according to claim 12, wherein the D-allose is produced through enzymatic conversion from the D-allulose.

14. A method for inhibiting or preventing crystallization of a liquid product comprising D-allulose, comprising adding D-allose or a composition comprising the same.

15. The method for inhibiting or preventing the crystallization of the liquid product comprising the D-allulose according to claim 14, wherein the D-allose is produced through enzymatic conversion from the D-allulose.

16. A method for producing a rare sugar liquid composition, comprising: enzymatically reacting a substrate of D-allulose to convert the D-allulose into D-allose; and separating and purifying unconverted D-allulose and D-allose.

17. The method for producing the rare sugar liquid composition according to claim 16, wherein an enzyme for converting the D-allulose into the D-allose is an aldose-ketose isomerase.

18. The method for producing the rare sugar liquid composition according to claim 16, wherein the converting is performed so that a content of D-allose in a produced composition is 20-40% (W/W) relative to a total weight.

19. The method for producing the rare sugar liquid composition according to claim 16, wherein the converting is performed so that a content of D-allose in a produced composition is 20-33% (W/W) relative to a total weight.

20. The method for producing the rare sugar liquid composition according to claim 16, further comprising adding the D-allose so that a content of D-allose in a produced composition is 5-50% (W/W) relative to a total weight.

21. The method for producing the rare sugar liquid composition according to claim 16, wherein a sugar concentration of the rare sugar liquid composition is 60-90 Brix.

22. The method for producing the rare sugar liquid composition according to claim 16, further comprising adding fructose as an additional sugar.

23. The rare sugar liquid composition produced by the method according to claim 16.
